(19) United States
(12) Patent Application Publication
(10) Pub. No.: US 2006/0093417 A1
(43) Pub. Date: May 4, 2006

(54) Fixing device

(75) Inventors: Osamu Watanabe, Tsurumi-ku (KR); Takashi Ando, Tsurumi-ku (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/263,844

(22) Filed: Nov. 2, 2005

(30) Foreign Application Priority Data
Nov. 2, 2004 (JP) 2004-319699
Aug. 6, 2005 (JP) 2005-72011

(51) Int. Cl. G03G 15/20

(52) U.S. Cl. 399/329

(57) ABSTRACT

A fixing device is provided comprising a pressing element which presses and contacts a supporter on an upstream side or a downstream side of an endless belt. Two bridging portions of the endless belt extend between the supporters, one bridging portion is tensed because one end of the bridging portion is pressed between the supporter and the pressing element, and the other bridging portion is tense-free. A fixing nip is formed at a contact between the pressing element and an outer surface of the tensed bridging portion.

### CROSS-REFERENCE TO RELATED PATENT APPLICATIONS

This application claims the benefit under 35 U.S.C. §119(a) of Japanese Patent Application No. P2004-319699, filed on Nov. 2, 2004, and Korean Patent Application No. 10-2005-0072011, filed on Aug. 6, 2005, the entire disclosures of which are hereby incorporated by reference. cl BACKGROUND OF THE INVENTION

1. Field of the Invention

The present invention relates to a fixing device. More particularly, the present invention relates to a fixing device built in a photolithographic image forming apparatus such as a laser printer, a laser facsimile, or a digital copier.

2. Description of the Related Art

In electrophotographic image forming apparatuses, the surface of a photoconductor drum is charged and then scanned by a laser scanning unit or the like to form an electrostatic latent image according to an image signal. Thereafter, charged toner is attached onto the photoconductor drum and developed by a developer to form a toner image. Then, the toner image is transferred to a paper sheet (recording medium). The toner image transferred to the paper sheet is seated on the sheet, that is, not fixed thereto, and the toner image is then fused with heat and pressure to fix the paper sheet by a fixing device.

A conventional fixing device basically includes a cylindrical metallic heat roller (an electrical heating element), a press roller (a pressing element) which presses and contacts the heat roller, and a halogen lamp (a heat source) installed in the heat roller to heat the heat roller with radiant heat. In the fixing device (2-roller type), the paper sheet having a toner image formed thereon is passed through a fixing nip formed between the heat roller and the press roller, which contact with each other with pressure, so that the toner image is heated by the heat roller and fixed onto the sheet by the pressure contact of the heat roller and the press roller.

However, it takes a rather long period of time for a conventional fixing device to heat the heat roller at room temperature to reach a fixing temperature of about 160 to 200° C. at which toner melts. Hence, a conventional fixing device spends a significantly long warm-up time before actual printing after power application. Furthermore, the fixing device maintains its temperature high because this shortens the time interval between print standby and print start. The fixing device needs to be heated with a halogen lamp to keep its temperature high. This results in increased power consumption.

To overcome these disadvantages of the conventional 2-roller type fixing device, there have been recent proposals for fixing devices capable of reducing both warm-up time and power consumption.

One of the proposed fixing devices is an induction heating (IH) fixing device which achieves heat generation by inducing current using magnetic flux. The IH fixing device basically includes a cylindrical or half-cylindrical holder, a cylindrical film fits into the holder comprising a stack of conductive and resistor layers, a magnetic field generating unit installed in the holder and comprised of an excitation coil and a magnetic core, and a press roller that presses and contacts an outer circumference of the film to form a fixing nip. In the IH fixing device, an Eddy current is generated by the magnetic flux generated by the magnetic field generating unit. As a result, Joule's heat is generated on the conductive layer by the Eddy current, and the temperature of the fixing nip is increased by the Joule's heat. Due to the IH, the temperature of the fixing nip can be increased to a fixing temperature within a short time period, and the warm-up time period can be reduced. Furthermore, as described in Japanese Patent Publication No. 2004-126274, the entire disclosure of which is hereby incorporated by reference; power consumption can be reduced because the cylindrical film has a low heat capacity compared to a heat roller. However, because the IH fixing device needs the magnetic field generating unit, it requires high costs for components compared to the 2-roller type fixing device. Moreover, because the inner surface of the film slides on a component such as the holder, the durability of the film is restricted due to abrasion of the holder portion on which the film slides. Therefore, the selection range of a material for the film is relatively narrow.

There is also a press belt pressing type fixing device in which a tube-shaped press belt is included instead of the press roller included in the 2-roller type fixing device. A fixing nip is formed by pressing a part of the inner surface of the press belt toward a heat roller so that an outer surface of the press belt corresponding to the pressed inner surface contacts the heat roller. The press belt pressing type fixing device basically includes a heat roller which is heated by a heat source such as a halogen lamp and axially rotates, an endless press belt which contacts the heat roller and is moved by a motion of the heat roller, and a pressing element which presses an inner surface of the press belt toward the surface of the heat roller so that an outer surface of the press belt corresponding to the pressed inner surface contacts the heat roller. As described in Japanese Patent Publication No. 2004-12682, the entire disclosure of which is hereby incorporated by reference, the fixing nip is wide because it is formed by pressing the press belt on the heat roller so that they contact each other. Accordingly, the warm-up time and power consumption can be reduced, and component costs can be reduced from those required by the IH fixing device. However, because the inner surface of the press belt is pressed by the pressing element and slides on the heat roller, the durability of the press belt or the pressing element is still restricted due to abrasion of the heat roller on which the press belt slides, and the selection range of a material for the press belt or the pressing element is still narrow.

Additionally, a heat belt type fixing device includes a cylindrical heat belt unit comprising an endless heat belt which is freely movable in a main direction is included instead of the heat roller included in the 2-roller type fixing device. A fixing nip is formed by contacting the heat belt with a cylindrical press roller with pressure. The heat belt type fixing device basically includes the heat belt unit manufactured by winding the endless heat belt on a support roller and the cylindrical heat roller. The cylindrical press roller presses a bridging portion of the heat belt ranging between the support roller and the heat roller to contact the bridging portion. A halogen lamp is installed in the heat roller or the press roller. In the heat belt type fixing device, a wide fixing nip is formed, so that the warm-up time and power consumption can be reduced. Furthermore, because no sliding occurs, no abrasion occurs. Therefore, numerous materials for the heat belt can be used. In addition, as described in Japanese Patent Publication No. 2004-205877, the entire disclosure of which is hereby incorporated by reference; component costs can be less than those for the IH fixing device.

However, because the heat belt in the heat belt type fixing device is supported by the support roller and the heat roller and is tensed, when the heat belt is rotated, it moves toward the shaft of the support roller. Alternatively, the heat roller may tilt due to an error due to the accuracy; assembly accuracy of each roller, or a widthwise deviation of the circumference of the heat belt.

Accordingly, there is a need for a fixing device which can reduce warm-up time, power consumption, and belt tilting to securely fix a toner image on a sheet.

### SUMMARY OF THE INVENTION

An aspect of the present invention is to address at least the above problems and/or disadvantages and to provide at least the advantages described below. Accordingly, an aspect of the present invention is to provide a fixing device which can reduce warm-up time, power consumption, and tilting of an endless belt to securely fix a toner image on a sheet and an image forming apparatus including the fixing device.

According to an aspect of the present invention, there is provided a fixing device including at least two supporters, an endless belt movably supported by the supporters in a main direction and comprising at least two bridging portions, a heat source which heats the endless belt, and a pressing element which presses on the endless belt to fuse and fix a toner image to a recording medium while passing the recording medium on which the toner image is electrostatically seated through a fixing nip formed between the belt and the pressing element. The pressing element presses and contacts one of the supporters at an upstream side or a downstream side of the endless belt. The at least two bridging portions of the belt extend between the supporters, one bridging portion is tensed because one end of the bridging portion is pressed between the supporter and the pressing element, and the other bridging portion is tense-free. The fixing nip is formed by contacting the pressing element with an outer surface of the tensed of the bridging portion and ranges from the location where the fixing belt is pressed between the supporter and the pressing element to a predetermined location on the upstream side.

A pinch element is installed on a lateral side of the supporter on the upstream side to press and contact the supporter, and the belt is pressed between the supporter and the pinch element.

According to another aspect of the present invention, there is provided an image forming apparatus including an image forming unit which electrostatically transfers a toner image onto a recording medium, and the above-described fixing device.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, and features, and advantages of certain embodiments of the present invention will be more apparent from the following description taken in conjunction with the accompanying drawings, in which:

FIG. 1 is a schematic diagram of a fixing device and an image forming apparatus including the same according to an embodiment of the present invention; and

FIG. 2 is a schematic diagram of a fixing device.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

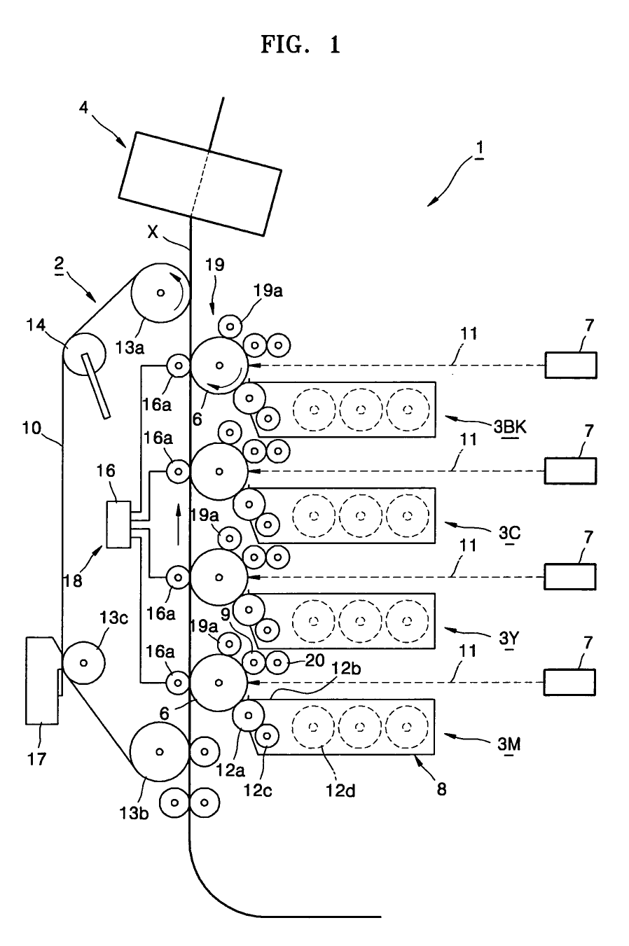

As shown in FIG. 1, the image forming apparatus 1 includes a transfer unit 2, a plurality of image forming units 3M, 3Y, 3C, and 3BK installed on the transfer unit 2 to electrostatically transfer a toner image to a sheet (recording medium) X, such as, paper, and a fixing device 4 for fusing and fixing the toner image onto the sheet X while carrying the sheet X having the toner image formed thereon.

The image forming units 3M, 3Y, 3C, and 3BK charges a photoconductor drum (image carrier) 6, perform exposure to form a latent image by scanning the surface of the charged photoconductor drum 6 with laser light 11, develops the latent image to form a toner image, and transfers the toner image to the sheet X transferred by a transfer belt 10. The image forming units 3M, 3Y, 3C, and 3BK are sequentially arranged along the transfer belt 10 in the direction of the sheet X transferred by the transfer belt 10 to form toner images of magenta, yellow, cyan, and black colors, respectively. Each of the image forming units 3M, 3Y, 3C, and 3BK includes a photoconductor drum 6, an exposure device 7, a developer 8, a charging roller 9, and a cleaning unit 19.

The photoconductor drum 6, which is an image carrier, axially rotates in the direction indicated by an arrow shown in FIG. 1 and is scanned with the laser light 11 emitted from the exposure device 7 to form a latent image. The exposure device 7 scans the surface of the photoconductor drum 6 with the laser light 11 in the direction parallel to the rotational axis of the photoconductor drum 6.

The developer 8 develops the latent image to form the toner image. More specifically, the developer 8 rubs powdered toner having a predetermined color with each other to charge the same with negative charges and provides and attaches the charged toner to exposed portions of the photoconductor drum 6 that have positive potentials compared to potentials of non-exposed portions thereof. The developer 8 includes toner, an agitator 12d for agitating the toner to charge the same with charges, a supply roller 12c for transferring the charged toner to a developing roller 12a. The developing roller 12a has the toner supplied by the supply roller 12c attached to its surface by a coulomb force generated by the charges of the toner, for transferring the toner to the photoconductor drum 6 to form a toner layer. A developing blade 12b restricts a thickness of the toner layer to a predetermined thickness.

The cleaning unit 19 includes a photoconductor drum cleaning roller 19a and a housing (not shown). The cleaning roller 19a comes into contact with the photoconductor drum 6 to remove toner from the surface of the photoconductor drum 6. The housing is installed near the cleaning roller 19a to collect the toner removed by the cleaning roller 19a.

The charging roller 9 changes a surface potential of the photoconductor drum 6 to a predetermined potential during image formation. The charging roller 9 includes a metal shaft and a roller portion formed of a conductive elastic body on the metal shaft and contacts the photoconductor drum 6 at a charging location on the downstream side of the photoconductor drum cleaning roller 19a. By pressing a bearing (not shown) using an elastic bias unit, such as, a spring, the charging roller 9 comes in contact with the photoconductor drum 6 by a predetermined width in the main direction to thereby form a nip corresponding to the predetermined width. When receiving a direct current voltage, the charging roller 9 charges the surface of the photoconductor drum 6 to have a predetermined potential. A charging roller cleaning roller 20 comes into contact with the charging roller 9 to prevent contamination of the surface of the charging roller 9.

The transfer unit 2 includes an endless transfer belt 10, a driving roller 13a, transfer rollers 16a, and a belt cleaning unit 17. The endless transfer belt 10 is circulated in one direction by driven rollers 13b and 13c and a tension roller 14, which are installed on an inner circumference of the transfer unit 2. The transfer rollers 16a keep the contact of the transfer belt 10 with the photoconductor drums 6 at a transferring location. The belt cleaning unit 17 includes a cleaning blade (not shown) for scraping extraneous matter off the surface of the transfer belt 10 and a space (not shown) for collecting the removed extraneous matter.

The transfer belt 10 is, for example, a dielectric sheet that can attract the toner on the photoconductor drum 6 by a transfer voltage applied to the transfer roller 16a when the sheet X exists between the transfer belt 10 and the photoconductor drum 6. The transfer belt 10 has an optical reflection property, that is, reflects light.

The transfer roller 16a is manufactured by forming a roller unit which may be formed of conductive or semi-conductive synthetic rubber) on a metal rotational shaft. A transfer high-voltage source (not shown) is connected to the rotational shaft to control a surface potential of the roller unit.

The transfer roller 16a and a controller 16 for controlling the surface potential of the rolling unit of the transfer roller 16a constitute a transfer portion 18 for electrostatically transfer the toner images formed by the image forming units 3M, 3Y, 3C, and 3BK to the sheet X carried by the transfer belt 10.

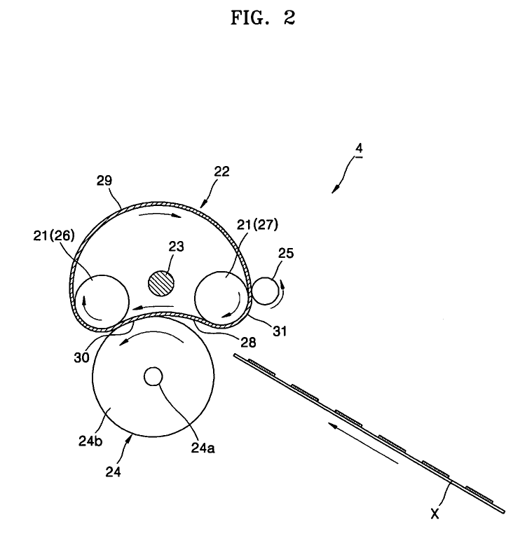

The fixing device 4 will now be described in greater detail with reference to FIG. 2. As shown in FIG. 2, the fixing device 4 includes two supporters 21, an endless (cylindrical) fixing belt 22 movably supported by the supporters 21 in the main direction, a heat source 23 installed inside the fixing belt 22 together with the supporters 21 to heat the fixing belt 22, a pressing element 24 pressing one supporter 21 on the downstream side of the transfer direction of the sheet X to contact a portion of the fixing belt 22 ranging from the supporter 21 on the downstream side to a certain location toward the upstream side thereof, and a pinch element 25 installed on the lateral side of the other supporter 21 on the upstream side.

The two supporters 21, each having a shape of a cylinder capable of axially rotating in one direction, are installed inside the cylindrical fixing belt 22. The supporter 21 on the downstream side (which is the left side of FIG. 2) of the transfer direction of the sheet X (which is a rotating direction of the pressing element 24) contacts the pressing element 24 via the fixing belt 22. On the other hand, the supporter 21 on the upstream side of the transfer direction of the sheet X is separated from the pressing element 24. The outer circumferential surface of the supporter 21 on the upstream side is partially covered by the fixing belt 22. The supporter 21 on the downstream side corresponds to a driving roller 26, which is axially rotated by a driving mechanism (not sown). The supporter 21 on the upstream side corresponds to a guide roller 27, which resists the motion of the fixing belt 22 in the main direction with a rotational resistance.

The fixing belt 22 is a thin element that has a length greater than a width of the sheet X and the shape of the fixing belt 22 is substantially cylindrcial when no external forces are applied. Furthermore, the fixing belt 22 is manufactured by sequentially stacking an elastic layer formed of heat-resistant rubber such as to a thickness of about several hundreds of microns and a toner release layer formed of highly heat-resistant fluorine resin or a modified material of fluorine resin, such as polytetrafluoroethylene, to a thickness of about several tens of microns on a base layer formed of a metal or heat-resistant resin film having a thickness of about 10 to 150 microns.

The fixing belt 22 is supported by the driving roller 26 and the guide roller 27 inside the fixing belt 22. The driving roller 26 supports the fixing belt 22 by interposing the fixing belt 22 between the driving roller 26 and the pressing element 24 in contact with each other and pressing the fixing belt 22 therebetween. The guide roller 27 supports the fixing belt 22 wound around a part of the out circumference thereof by pressing the fixing belt 22 on the pinch element 25. Accordingly, an inner surface of the fixing belt 22 is pressed on the driving roller 26 and the guide roller 27 and rubs against and contacts the driving roller 26 and the guide roller 27. The fixing belt 22 is movable in the main direction via the axially rotating driving roller 26.

By rotating the driving roller 26, a bridging portion 28 of the fixing belt 22, which ranges between the driving roller 26 and the guide roller 27 and is close to the pressing element 24, is tensed because both ends thereof are respectively pressed between the driving roller 26 and the pressing element 24 and between the guide roller 27 and the pinch element 25. Meanwhile, a bridging portion 29 of the fixing belt 22, which also ranges between the driving roller 26 and the guide roller 27 and is far from the pressing element 24, is not tensed.

The heat source 23 can be a halogen lamp. The heat source 23 includes a main body installed within the fixing belt 22 to heat the fixing belt 22 using radiant heat emitted by the main body. The heat source 23 is installed so that the main body is disposed in the vicinity of a fixing nip 30 formed by the contact of an outer surface of the tensed bridging portion 28 of the fixing belt 22 with the pressing element 24.

The pressing element 24 has a shape of a cylinder and is axially rotatable in one direction. The pressing element 24 may be manufactured by winding a heat-resistant elastic layer 24b, such as a silicon rubber layer, around a metallic core base 24a. The pressing element 24 presses and contacts a portion of the tensed bridging portion 28 ranging from one end pressed between the pressing element 24 and the driving roller 26 to a predetermined portion in the direction of the guide roller 27. The contact portion is the fixing nip 30. Tangential pressure is exerted upon the fixing nip 30 via a tension of the tensed bridging portion 28. The pressure upon the fixing nip 30 increases from an upstream end of the fixing nip 30 to a downstream end thereof (toward the driving roller 26), because the downstream end is pressurized by the driving roller 26 and the bridging portion 28 is pressed between the driving roller 26 and the pressing element 24. Hence, the toner image on the sheet X passing through the fixing nip 30 is pressed with an increasing force as it travels toward the driving roller 26. The pressing element 24 is axially rotated by the fixing belt 22 and moves in a main direction because it presses on and directly contacts the outer circumferential surface of the fixing belt 22.

The pinch element 25 has a shape of a cylinder and is axially rotatable in one direction. The pinch element 25 is installed so that a rounding portion 31 of the fixing belt 22 is wound around the supporter 21 on the upstream side and is interposed between the pinch element 25 and the supporter 21 and pressed therebetween. The pinch element 25 is also axially rotated by the moving fixing belt 22 because it directly contacts the outer circumferential surface of the fixing belt 22.

An operation of the image forming apparatus 1 having the aforementioned structure will now be described in detail. Because the entire operation of the image forming apparatus 1 is substantially the same as an operation of a conventional color printer, many parts except an operation of the fixing device 4 will be omitted for clarity and conciseness.

First, when the image forming apparatus 1 is manipulated, the heat source 23 is driven to perform a warm-up process to start heating. More specifically, heating continues until the temperature of the fixing device 4 reaches a predetermined fixing temperature. At this time, the driving roller 26 is axially rotated by a driving mechanism (not shown), and simultaneously the fixing belt 22 is moved by the rotating driving roller 26 in the main direction. When the fixing belt 22 moves, the guide roller 27, the pinch element 25, and the pressing element 24 are axially rotated via moving the fixing belt 22. Because the temperature of the image forming apparatus 1 increases due to radiation of heat by the fixing device 4, a fan (not shown) generates forced convection around the fixing device 4 to cool the inside of the image forming apparatus 1.

Next, when the temperature of the fixing device 4 reaches the predetermined fixing temperature, the image forming units 3M, 3Y, 3C, and 3BK start forming images on the sheet X transferred by the transfer belt 10. More specifically, the surface of the photoconductor drum 6 charged by the charging roller 9 is scanned with the laser light 11 to form a latent image. The latent image is developed by the developer 8 to form a toner image. The toner image formed on the surface of the photoconductor drum 6 is transferred to the sheet X transferred by the transfer belt 10.

Thereafter, the sheet X, on which the toner image is seated, is transferred to the fixing device 4, and the toner image is fused to the sheet X while the sheet X passes between the fixing belt 22 and the pressing element 24. More specifically, while the fixing belt 22 is moving in the main direction, the sheet X on which the toner image is seated is carried within the fixing nip 30 between the fixing belt 22 and the pressing element 24 through the upstream end (that is, the right side of the fixing nip 30 in FIG. 2). The toner image on the sheet X within the fixing nip 30 is slowly fused by the heated fixing belt 22 and fixed to the sheet X by the pressing element 24. The sheet X, to which the toner image is fixed, is carried out of the fixing nip 30 through the downstream end (that is, the left side of the fixing nip 30 in FIG. 2).

In this process, since the bridging portion 28 is pressed between the driving roller 26 and the pressing element 24 due to the tight contact of the downstream end of the fixing nip 30 with the pressing element 24 by the driving roller 26, the pressure upon the fixing nip 30 increases from the upstream end of the fixing nip 30 to the downstream end thereof near the driving roller 26. Hence, the toner image carried in the fixing nip 30 is pressed with increasing pressure as it travels toward the driving roller 26 and is pressed at the driving roller 26. Consequently, the toner image is sufficiently fused and then fixed to the sheet X.

In the fixing device 4, the pressing element 24 presses down on one of the two supporters 21 on one of the upstream and downstream sides of the fixing belt 22, and the wide fixing nip 30 is formed by pressing the pressing element 24 on the tensed bridging portion 28 of the fixing belt 22 between the two supporters 21. Thus, a relatively long period of fixing time can be secured, and sufficient fixing is possible. Furthermore, because the fixing belt 22, which is heated has a low-heat capacity, the warm-up time and power consumption can be reduced. Moreover, the bridging portion 28 near the pressing element 24 can be tensed by the pressing element 24 pressing and contacting the supporter 21 on the upstream or downstream sides, and a pressure inclination can be applied to the fixing nip 30. Thus, the toner image can be more securely fixed to the sheet X. In addition, because the bridging portion 29 not contacting the pressing element 24 is tension-free, the bridging portion 29 can absorb a deformation of the fixing belt 22 or a motion of the fixing belt 22 that is caused by a distortion of the cross-sectional shapes of the supporters 21. Consequently, the bridging portion 29 can prevent the fixing belt 22 from moving in the axial direction of the supporters 21. Further, because the fixing device 4 is not comprised of expensive components, it is economical.

In the fixing device 4, the pinch element 25 presses and contacts the fixing belt 22 interposed between the pinch element 25 and the lateral side of the supporter 21 on the upstream side of the fixing belt 22. The pressing element 24 presses and contacts the fixing belt 22 interposed between the pressing element 24 and the supporter 21 on the downstream side. Thus, the wide fixing nip 30 is formed, and a pressure inclination from the upstream to the downstream can be applied to the fixing nip 30, so that the end of the fixing nip 30 near the upstream side can be more strongly pressed. Thus, the long fixing time can be secured, and sufficient fixing is possible. Furthermore, because the fixing belt 22 which is heated has a low-heat capacity, the warm-up time and power consumption can be reduced. Moreover, since a fusion of a toner image occurring while moving within the fixing nip 30 increases from the upstream side to the downstream side, the toner image on the downstream can be fixed to the sheet X with high pressure. The toner image can be carried out of the fixing nip 30 and is more securely fixed to the sheet X.

In addition, because the fixing belt 22 is pressed between the supporter 21 on the downstream and the pressing element 24, and between the supporter 21 on the upstream and the pinch element 25, the bridging portion 28 near the pressing element 24 can be securely tensed. Additionally, the bridging portion 29, located away from the pressing element 24, can be tension-free.

The fixing device 4 reduces warm-up time, power consumption, and the tilting of the fixing belt 22 and includes low-cost components. As a result, the image forming apparatus 1 can provide shortened warm-up time and reduced power consumption and does not easily cause mechanical defects even with low costs.

The two supporters 21 for supporting the fixing belt 22 each include the driving roller 26 and the guide roller 27, which are axially rotatable, and the pressing element 24 pressing and contacting the bridging portion 28 of the fixing belt 22. The two supports have a shape of an axially rotatable roller, which is substantially cylindrical. Thus, no sliding occurs on the fixing belt 22, and the fixing belt 22 does not abrade.

While the present invention has been particularly shown and described with reference to the embodiment shown in FIGS. 1 and 2, it will be understood by those of ordinary skill in the art that various changes in form and details may be made therein without departing from the spirit and scope of the present invention as defined by the following claims. For example, in the above-described embodiment, the supporter 21 on the downstream side is pressed by the pressing element 24, and the supporter 21 on the upstream side is pressed by the pinch element 25. However, the supporter 21 on the downstream side may be pressed by the pinch element 25, and the supporter 21 on the upstream side may be pressed by the pressing element 24. Additionally, the heat source 23 is installed inside the endless fixing belt 22 without contacting the inner circumferential surface thereof. However, the heat source 23 may be installed within the supporter 21 on the upstream side and heat the supporters using radiant heat so that the fixing belt 22 is heated by the heated supporters. Alternatively, the heat source 23 may be installed outside the endless fixing belt 22 and contact an electrical heating element to directly heat the same.

While the two supporters 21 are installed on the upstream and downstream sides of the endless belt in the above-described embodiment, more than two supporters 21 may be installed. If three supporters are installed, supporters on the upstream and downstream sides may be guide rollers, and the other supporter may be a driving roller.

The guide roller 27, namely, the supporter 21 on the upstream side, has a rotational resistance and resists a main-direction motion of the fixing belt 22 to tense the bridging portion 28 and loosen the bridging portion 29. However, the bridging portion 28 and the bridging portion 29 may be tensed and loosened by axially rotating the supporter 21 on the downstream side at a higher linear speed than that for the supporter 21 on the upstream side using a driving mechanism and rubbing the fixing belt 22 and the driving roller 26 against each other more strongly than for the fixing belt 22 and the guide roller 27.

In the above-described embodiment, the image forming apparatus 1 includes the plurality of image forming units 3M, 3Y, 3C, and 3BK to achieve color printing. However, an image forming apparatus according to the present invention may be an image forming apparatus for performing monochromic printing by including one image forming unit. Also, since the fixing nip 30 is wide enough to lengthen the heating and fusing time, it is particularly effective for color-printing apparatuses in which a color toner image which is difficult to fuse and fix to a recording medium.

A recording medium is not limited to the sheet X but may be a plate-shaped recording medium. The shape and material of the recording medium may adequately vary.

While the invention has been shown and described with reference to certain embodiments thereof, it will be understood by those skilled in the art that various changes in form and details may be made therein without departing from the spirit and scope of the invention as defined by the appended claims.

What is claimed is:

1. A fixing device, comprising:
at least two supporters;
an endless belt movably supported by the supporters in a main direction and comprising two bridging portions extending between the supporters;
a heat source which heats the endless belt;
a pressing element pressed on the endless belt which fuses and fixes a toner image to a recording medium while passing the recording medium on which the toner image is electrostatically seated through a fixing nip formed between the belt and the pressing element;
wherein the pressing element presses and contacts the supporters at one of an upstream side and a downstream side of the transfer of the recording medium, and one of the bridging portions is tensed because one end of the bridging portion is pressed between the supporter and the pressing element, and the other bridging portion is tense-free, and the fixing nip is formed by contacting the pressing element with an outer surface of the tensed bridging portion and ranges from the location where the fixing belt is pressed between the supporter and the pressing element to predetermined location on the upstream side.

2. The fixing device of claim 1, wherein a pinch element is installed on a lateral side of the supporter on the upstream side to press and contact the supporter, and the belt is pressed between the supporter and the pinch element.

3. The fixing device of claim 1, wherein the supporters are located on the upstream and the downstream sides of the endless belt, respectively, and the pressing element presses one of the supporters on the upstream and downstream sides.

4. The fixing device of claim 3, wherein the pressing element presses and contacts the supporter on the upstream side, and the pinch element presses and contacts the lateral side of the support member on the downstream side.

5. The fixing device of claim 3, wherein the pressing element presses and contacts the supporter on the downstream side, and the pinch element presses and contacts the lateral side of the supporter on the upstream side.

6. The fixing device of claim 3, wherein the supporter on the downstream side rubs against and contacts the inner surface of the belt and drives the belt, and the supporter on the upstream side is rotated by the moving belt.

7. The fixing device of claim 1, wherein the fixing belt is a stack of at least an elastic layer that forms the fixing nip by compression and a toner release layer that comprises an outermost surface of the fixing belt.

8. The fixing device of claim 1, wherein a pressure upon the fixing nip increases in the direction where the recording medium is transferred.

9. A fixing device, comprising:
at least two supporters;
an endless belt movably supported by the supporters in a main direction and comprising two bridging portions extending between the supporters; and
a pressing element pressed on the endless belt which fuses and fixes a toner image to a recording medium;
wherein the pressing element presses and contacts one of the supporters at an upstream side and a downstream side of the transfer of the recording medium, and one of the bridging portions is tensed because one end of the bridging portion is pressed between the supporter and the pressing element, and the other bridging portion is tense-free, and a fixing nip is formed by contacting the pressing element with an outer surface of the tensed bridging portion.

10. The fixing device of claim 9, wherein a pinch element is installed on a lateral side of the supporter on the upstream side to press and contact the supporter, and the belt is pressed between the supporter and the pinch element.

11. The fixing device of claim 9, wherein the supporters are located on the upstream and the downstream sides of the endless belt, and the pressing element presses one of the supporters on the upstream and downstream sides.

12. The fixing device of claim 11, wherein the pressing element presses and contacts the supporter on the upstream side, and the pinch element presses and contacts the lateral side of the supporter on the downstream side.

13. The fixing device of claim 1 1, wherein the pressing element presses and contacts the supporter on the downstream side, and the pinch element presses and contacts the lateral side of the supporter on the upstream side.

14. The fixing device of claim 11, wherein the supporter on the downstream side rubs against and contacts the inner surface of the belt and drives the belt, and the supporter on the upstream side is rotated by the moving belt.

15. The fixing device of claim 9, wherein the fixing belt is a stack of at least an elastic layer that forms the fixing nip by compression and a toner release layer that comprises an outermost surface of the fixing belt.

16. The fixing device of claim 9, wherein a pressure upon the fixing nip increases in the direction where the recording medium is transferred.
